(19) United States
(12) Patent Application Publication
(10) Pub. No.: US 2014/0231399 A1
(43) Pub. Date: Aug. 21, 2014

(54) CONNECTION FITTING AND CONNECTION METHOD USING THE SAME

(71) Applicant: Kabushiki Kaisha Kobe Seiko Sho (Kobe Steel, Ltd.), Kobe-shi (JP)

(72) Inventors: Makoto KONDO, Fujisawa-shi (JP); Tatsuji MINATO, Fujisawa-shi (JP); Tamami MORISHITA, Shizuoka-shi (JP); Shinya ONO, Shizuoka-shi (JP)

(73) Assignee: Kabushiki Kaisha Kobe Seiko Sho (Kobe Steel, Ltd.), Kobe-shi (JP)

(21) Appl. No.: 14/168,434

(22) Filed: Jan. 30, 2014

(30) Foreign Application Priority Data
Feb. 18, 2013 (JP) 2013-029171

(51) Int. Cl. B23K 9/095; B23P 19/00

(52) U.S. Cl. CPC B23K 9/0956; B23P 19/00
USPC 219/130.21; 29/525.14

(57) ABSTRACT

Provided is connection fitting and method. The connection fitting is to connect each of two connection portions of a two-electrode-integrated welding torch unit to each of two attachment ports of a shock sensor unit while fixed to the connection portion using tubular fastening parts, comprising: a tubular fitting body including a first end to be connected to the unit and a second end having a spherical shaft-shaped connection portion with first and second partial spherical surfaces to be connected to the connection portion; a first bearing member having a first sliding surface slidable against the first partial spherical surface; a second bearing member having a second sliding surface slidable against the second partial spherical surface. The second bearing member has a sliding contact portion having an outer diameter smaller than an inner diameter of the fastening parts and adapted to slidably contact an end surface of the connection portion.

### BACKGROUND OF THE INVENTION

1. Technical Field

The present invention relates to a connection fitting for connecting a pair of welding torches constructed as a two-electrode integrated welding torch unit to a shock sensor, and a connection method using the connection fitting.

2. Description of the Background Art

Heretofore, as a welding torch for realizing tandem arc welding using two welding wires, there has been developed a two-electrode integrated welding torch unit, as described, for example, in the paragraphs [0025] and [0037] and FIG. 1 in JP 2003-39172A. The two-electrode integrated welding torch unit has a pair of torch bodies, which define therebetween an angle from 3 to 15 degrees. The torch bodies have respective base ends, to which a connection fitting is attached while keeping the angle. Through the connection fitting, a torch cable from a wire feeding unit is connected to the torch body. Hence, the angle between the connection fittings is also from 3 to 15 degrees.

Meanwhile, as a welding robot for realizing a single arc welding using one welding wire, there has been proposed a technique of installing, between a welding torch and a wrist portion (robot arm), a shock sensor (shock sensor unit) for detecting a tilt and an axial displacement of the welding torch, when the welding torch comes into contact or collision with an object such as a workpiece or a jig, to stop operation of the welding robot, as described, for example, in the paragraph [0006] and FIGS. 1 and 2 in JP 2004-351510A.

However, with regard to a welding robot equipped with the two-electrode integrated welding torch unit, there has been no proposal of installing a shock sensor compatible with the two-electrode integrated welding torch unit, i.e., a tandem-compatible shock sensor unit, between the pair of welding torches and a wrist portion (robot arm). One reason why is that the tandem-compatible shock sensor unit has to elastically hold the welding torches in such a manner to allow the welding torches to be automatically returned to their respective origin positions after they are tiltingly or axially displaced due to contact or collision, and therefore has to have a structure including two welding torch holding portions to hold the respective welding torches at the origin positions and further the two welding torch holding portions have to be located parallel to each other. Therefore, as in a tandem-compatible shock sensor 100 and a two-electrode integrated welding torch unit 101 shown in FIG. 10, an angle between two connection fittings 102 and an angle between two welding torch holding portions 104 are different from each other, which prevents the two-electrode integrated welding torch unit from being attached to the tandem-compatible shock sensor without any modification.

As a way to cope with this problem, it is conceivable to subject each of the torch bodies of the two-electrode integrated welding torch unit to bending so as to allow the connection fittings to be parallel to each other; however, this bending has some disadvantages as follows.

A first one of the disadvantages is that the bending against the torch body is limited to one for obtaining a simple and shallow curve because it is necessary to reduce a curvature of a curved portion as small as possible in order not to impair feedability of a welding wire to be fed while being penetratingly inserted into the torch body.

A second one of the disadvantages is that the bending is difficult, because the torch body is based on an assumption of a curved type having a bent portion 106 corresponding to a desired curve of a welding wire, for example, as in a torch body 105 of a welding torch 101 shown in FIG. 11, and therefore the bending for allowing the connection fittings to become parallel to each other requires a 3-dimensional directional adjustment, which involves difficult angle setting and position setting.

A third one of the disadvantages is that, assuming a use of cupper as a material for the torch body, it is difficult to obtain intended curved dimensions at a high degree of accuracy while the bending is facilitated. The shock sensor unit, which is to be connected to the torch body, has to be bent with a high degree of accuracy (e.g., accuracy within the range of 0.1 to 0.2 mm).

As above, although the two-electrode integrated welding torch unit can be attached to the tandem-compatible shock sensor by subjecting each of the torch bodies of the two-electrode integrated welding torch unit to bending so as to allow the connection fittings to be parallel to each other, there is a problem that the bending requires a high degree of skill and a lot of time. There is another problem that, due to influences of the curved shape of each of the torch bodies and the angle defined between the torch bodies, assembling between the two-electrode integrated welding torch unit and the tandem-compatible shock sensor also requires a high degree of skill and a lot of time.

### SUMMARY OF THE INVENTION

It is an object of the present invention to provide a connection fitting capable of interconnecting a two-electrode integrated welding torch unit and a tandem-compatible shock sensor unit within a short period of time, involving no needs for process and adjustment times, and a high degree of skill based on experts, necessary for ensuring torch bending accuracy and assembling accuracy. It is another object of the present invention to provide a connection method using the connection fitting.

According to one aspect of the present invention, provided is a connection fitting for interconnecting a two-electrode integrated welding torch unit having two connection portions and a shock sensor unit having two attachment ports, wherein the connection fitting is adapted to be fixed to each connection portion of the two-electrode integrated welding torch unit by use of tubular fastening parts to connect each of the connection portions of the two-electrode integrated welding torch unit to corresponding one of the attachment ports of the shock sensor unit. The connection fitting comprises: a tubular fitting body including a first end formed with a tubular connection portion to be connected to the shock sensor unit and a second end which is opposite to the first end, the second end having a spherical shaft-shaped connection portion which is integrally formed with a first partial spherical surface and a second partial spherical surface each having a difference curvature to be connected to the connection portion of the two-electrode integrated welding torch unit; a first bearing member ring-shaped to have an inner surface formed with a first sliding surface slidable with respect to the first partial spherical surface of the spherical shaft-shaped connection portion, the first bearing member being configured to be attached to the fitting body from a first-end side of the tubular fitting body in a state in which the first partial spherical surface and the first sliding surface are opposed to each other; a second bearing member ring-shaped to have an inner surface formed with a second sliding surface slidable with respect to the second partial spherical surface of the spherical shaft-shaped connection portion, the second bearing member being configured to be attached to the fitting body from a second-end side of the tubular fitting body in a state in which the second partial spherical surface and the second sliding surface are opposed to each other and the second bearing member contacts an end surface of the connection portion of the two-electrode integrated welding torch unit, wherein the second bearing member includes a sliding contact portion having an outer diameter less than an inner diameter of the fastening parts and configured to slidably contact the end surface of the connection portion of the two-electrode integrated welding torch unit.

According to another aspect of the present invention, provided is a method of connecting a two-electrode integrated welding torch unit to a shock sensor unit installed at a distal end of a robot arm, using the above connection fitting. The method comprises: a first step of placing the spherical shaft-shaped connection portion to which the first bearing member and the second bearing member has been attached, inside the tubular fastening parts, in a temporarily fastened state, to expose the tubular connection portion of the connection fitting to an outside of the fastening parts; a second step of connecting the tubular connection portion to the shock sensor unit and fastening the fastening parts; and a third step of brazing the fitting body, the first bearing member and the second bearing member to the fastening parts with use of an electrical conductive brazing filler metal.

### BRIEF DESCRIPTION OF THE DRAWINGS

FIG. 1 is a side view illustrating a welding robot equipped with a connection fitting according to one embodiment of the present invention.

FIG. 2 is a partially-sectional top plan view of a robot arm of the welding robot shown in FIG. 1.

FIG. 3 is a partially-sectional side view of the robot arm of the welding robot shown in FIG. 1.

FIG. 4 is an exploded perspective view of the robot arm of the welding robot in FIG. 1.

FIG. 5 is a partially-sectional exploded perspective view of the connection fitting according to the embodiment.

FIG. 6 is an exploded vertical sectional view of the connection fitting according to the embodiment.

FIG. 7 is a sectional view for explaining an angle adjustment function of the connection fitting according to the embodiment.

FIG. 8 is a sectional view for explaining a position adjustment function (offset adjustment function) of the connection fitting according to the embodiment.

FIGS. 9A, 9B, 9C and 9D are respective sectional views for explaining a connection method using the connection fitting according to the embodiment.

FIG. 10 is a top plan view for explaining a problem in a situation of connecting a conventional two-electrode integrated welding torch unit to a tandem-compatible shock sensor unit.

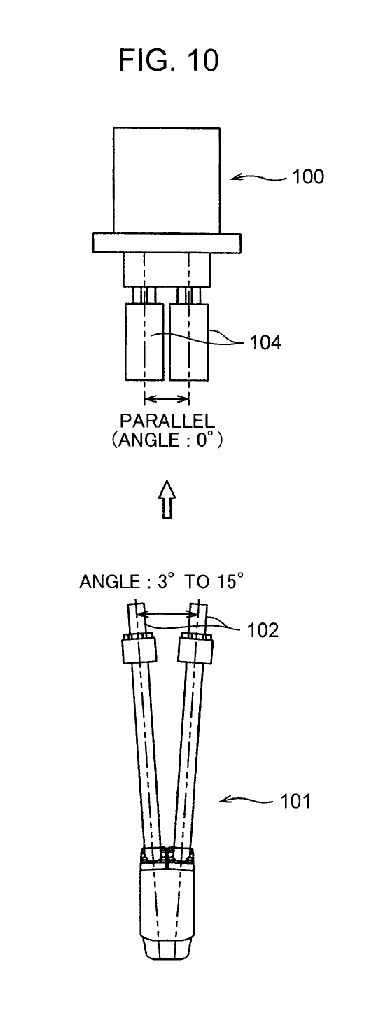

FIG. 11 is an explanatory diagram illustrating a conventional curved type welding torch.

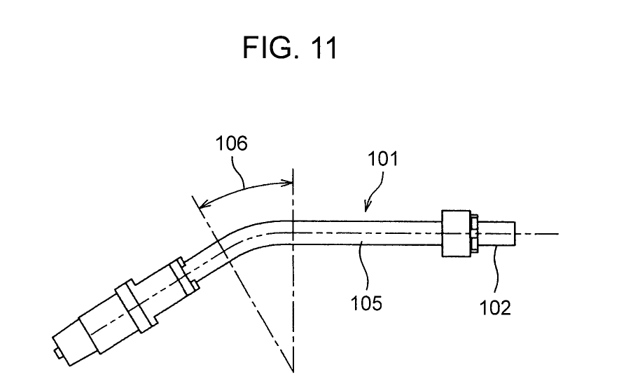

### DESCRIPTION OF THE PREFERRED EMBODIMENTS

With reference to the drawings, an embodiment of the present invention will now be described in detail. It should be noted that the figures schematically illustrate the present invention to an extent sufficiently enough to allow a person skilled in the art to understand it. Therefore, the present invention is not limited to the shown embodiment. It should be also noted that, in the figures, dimensions of some elements or members in the present invention are exaggeratingly depicted in order to clarify the description. In the figures, common or similar elements or members are assigned with the same reference numeral or code, and their duplicated description will be omitted.

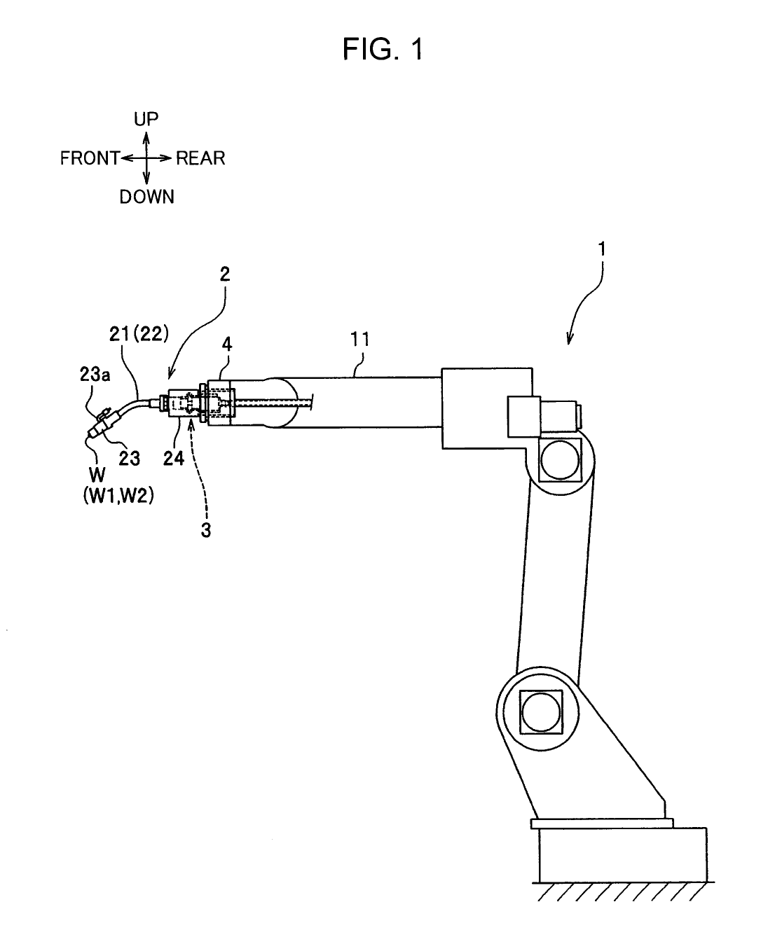

In the following embodiment, up-down and right-left directions of a tandem welding torch unit 2 are changed depending on a state of a welding operation during welding. For the reason, the embodiment of the present invention will be described on an assumption that an upper side, a lower side, a left side and a right side in FIG. 1 are defined, respectively, as “up or upward”, “down or downward”, “front or frontward” and “rear or rearward”.

### <<Configuration of Welding Robot>>

FIG. 1 shows a welding robot 1, which is an automatic welding apparatus capable of performing highly-efficient and high-speed welding, the welding robot 1 including a tandem welding torch unit 2 to simultaneously create electric arcs using two welding wires W (first electrode W1, second electrode W2) to perform tandem welding. The welding robot 1 is an welding apparatus designed to perform arc welding, while supplying a welding current and the welding wires W each unwound from a pool of a non-shown wire feeding unit to be automatically fed to the tandem welding torch unit 2.

The welding robot 1 primarily comprises: the tandem welding torch unit 2 to perform welding on a workpiece; a power supply (not shown) for supplying current to the welding wires W; the wire feeding unit (not shown) for feeding the welding wires W each wound around the pool thereof; and a robot arm 11 for moving the tandem welding torch unit 2. The tandem welding torch unit 2 is attached to a distal end of the robot arm 11 via a tandem-compatible shock sensor unit 3.

### <Configuration of Tandem Welding Torch Unit>

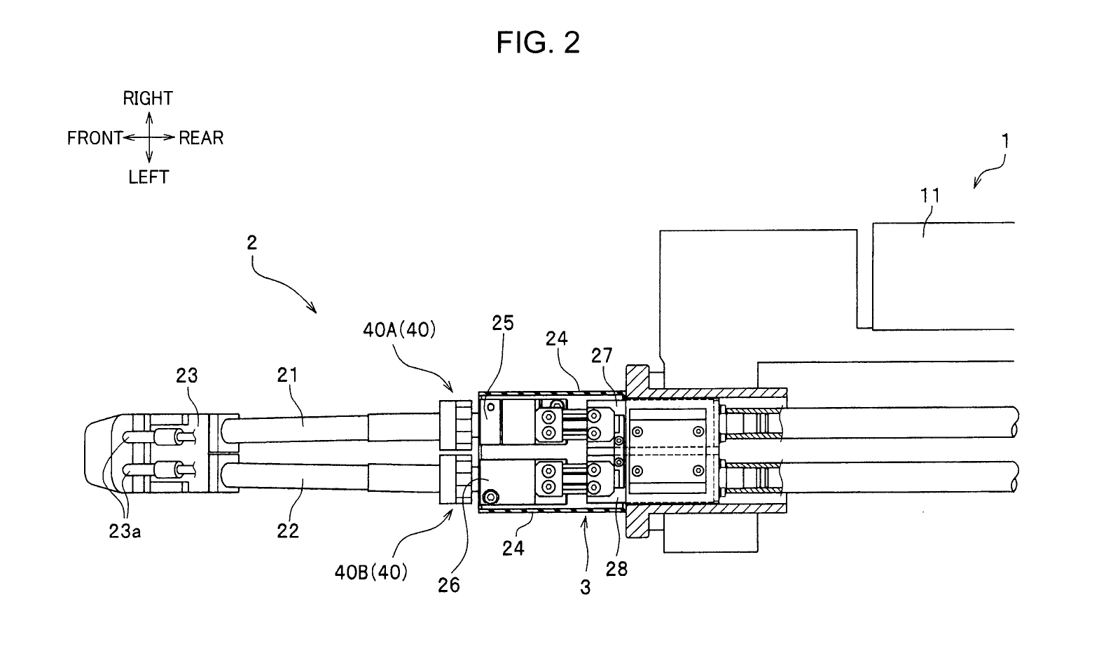

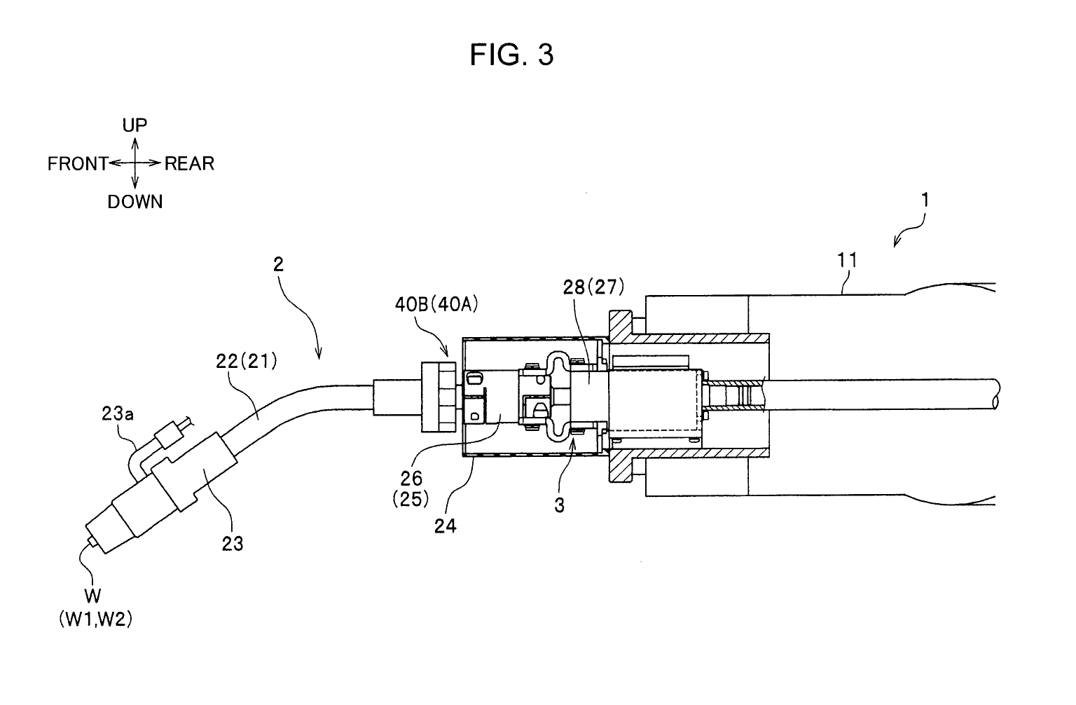

As shown in FIGS. 2 and 3, the tandem welding torch unit 2 is a two-electrode integrated welding torch unit having two welding torches 21, 22. The tandem welding torch unit 2 is a device which uses a pair of welding wires W for welding on a workpiece and supplies a welding current to each of the welding wires W while supplying shielding gas to perform welding.

### (Configuration of Welding Torches)

As shown in FIGS. 2 and 3, the welding torches 21, 22 are arranged so as to define an angle of a predetermined value (e.g., 2 to 15 degrees) between respective axes thereof, thereby forming a double torch unit consisting of two torches. Each of the welding torches 21, 22 is constituted by a hollow cylindrical or tubular member capable of allowing the welding wire W shown in FIG. 3 to be penetratingly inserted thereinto.

The welding torches 21, 22 has respective front ends fixed to a torch fixing member 23 and respective rear ends fixed to the tandem-compatible shock sensor unit 3 through respective connection fittings 40A, 40B.

The torch fixing member 23 is fixed commonly to respective front ends of the two welding torches 21, 22. The torch fixing member 23 has a pair of hose connection portions 23a on an upper side portion thereof to supply cooling water from a non-shown cooling-water supply source to the welding torches 21, 22 via respective hoses.

### <Configuration of Shock Sensor Unit>

The tandem-compatible shock sensor unit 3 shown in FIGS. 2 and 3 is a protective device for detecting a tilt and an axial displacement of the welding torches 21, 22 due to contact or collision of the welding torches 21, 22 with an object such as a workpiece or a jig to stop an operation of the welding robot 1.

The shock sensor unit 3 primarily comprises: a first base-end torch holding member 25 for holding a rear end (base end) of a first one 21 of the welding torches; a second base-end torch holding member 26 for holding a base end of the other, second, welding torch 22; and two shock sensors 27, 28 supporting the first and second base-end torch holding members 25, 26, respectively, so as to allow the first and second base-end torch holding members 25, 26 to be tilted and axially (in FIGS. 2 and 3, front-rear directionally) displaced and to be elastically and automatically returned. The shock sensor unit 3 is thereby enabled to detect the tilt and axial displacements of each of the welding torches 21, 22. A part of the shock sensor unit 3 is covered by an insulation cover 24 composed, for example, of an insulating member such as a circular tubular rubber member.

### <Configuration of Connection Fittings>

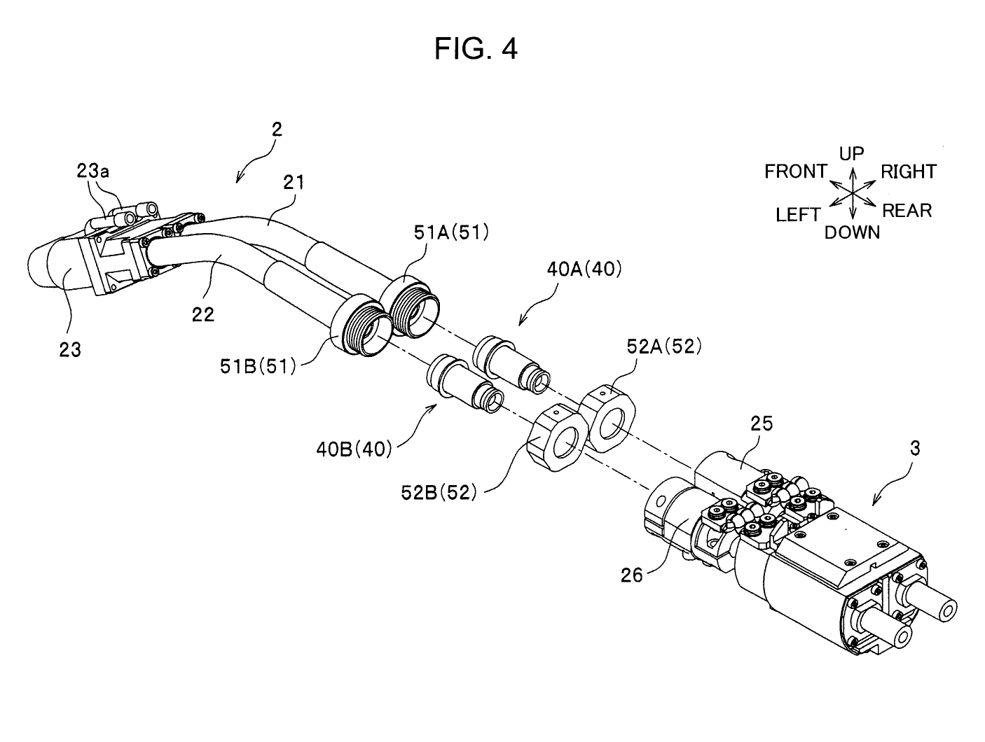

The connection fittings 40A, 40B shown in FIGS. 2 and 3 are members for interconnecting the tandem welding torch unit 2 and the shock sensor unit 3 while allowing respective positional misalignments and angular misalignments occurring between the welding torches 21, 22 and respective first and second base-end torch holding member 25, 26 to be adjusted. As shown in FIG. 4, in a state in which respective front ends of the connection fittings 40A, 40B are respectively housed in two housing members 51A, 51B installed onto respective rear ends of the welding torches 21, 22, two clamp members 52A, 52B are fastened to the housing members 51A, 51B, respectively, so as to prevent the connection fittings 40A, 40B from dropping out of the welding torches 21, 22, while respective rear ends of the connection fittings 40A, 40B are connected to the shock sensor unit 3. In view of current conductivity, the connection fittings 40A, 40B are preferably made of the same material as that for the welding torches 21, 22.

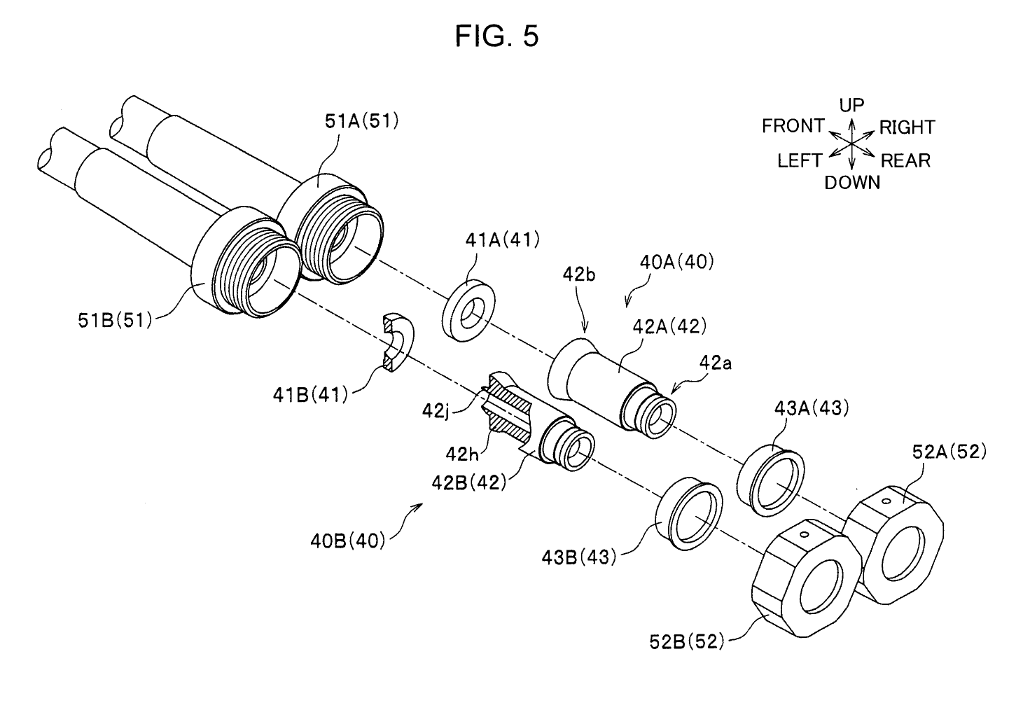

In a temporarily fastened state in which, before aftermentioned brazing, the clamp members 52A, 52B are connected to the housing member 51A, 51B but have not been fully fastened to respective housing members 51A, 51B yet, the connection fittings 40A, 40B can be moved within respective housing members 51A, 51B, in a direction perpendicular to a central axis thereof extending the front-rear direction in FIG. 4, that is, in the up-down and right-left directions. The connection fittings 40A, 40B have respective fitting bodies 42A, 42B shown in FIG. 5, and each of the fitting bodies 42A, 42B can be tilted with respect to the central axis (front-rear direction in FIG. 4) in the temporarily fastened state.

On the other hand, in a finally fastened state in which the clamp members 52A, 52B have been fully fastened to respective housing members 51A, 51B by use of a tool such as a spanner or screw wrench, each of the connection fittings 40A, 40B is constrained so as to be prevented from tilt or movement in the direction perpendicular to the central axis, thus being fixed in a tilted state at a position to which the connection fittings 40A, 40B had been moved. The connection fittings 40A, 40B has a position adjustment function (offset adjustment function) of adjusting a positional misalignment generated between respective axes of the welding torches 21, 22 and respective axes of the first and second base-end torch holding members 25, 26 of the shock sensor unit 3, respectively, and an angle adjustment function of adjusting an angular misalignment between the axes.

As shown in FIG. 5, the connection fittings 40A, 40B have respective torch-side bearing members 41A, 41B each equivalent to “second bearing member” set forth in the appended claims, the fitting bodies 42A, 42B, and respective sensor-side bearing members 43A, 43B each equivalent to “first bearing member” set forth in the appended claims. In FIG. 5, the connection fitting 40A and the connection fitting 40B have the same configuration. A part of each of the connection fitting 40B and the torch-side bearing member 41B is graphically shown in cross-section to show their respective internal shapes. In the following description, there are following cases: either one of the connection fitting 40A and the connection fitting 40B will be referred to occasionally as “connection fitting 40”; either one of the torch-side bearing member 41A and the torch-side bearing member 41B will be referred to occasionally as “torch-side bearing member 41”; and either one of the sensor-side bearing member 43A and the sensor-side bearing member 43B will be referred to occasionally as “sensor-side bearing member 43”.

### (Configuration of Fitting Body)

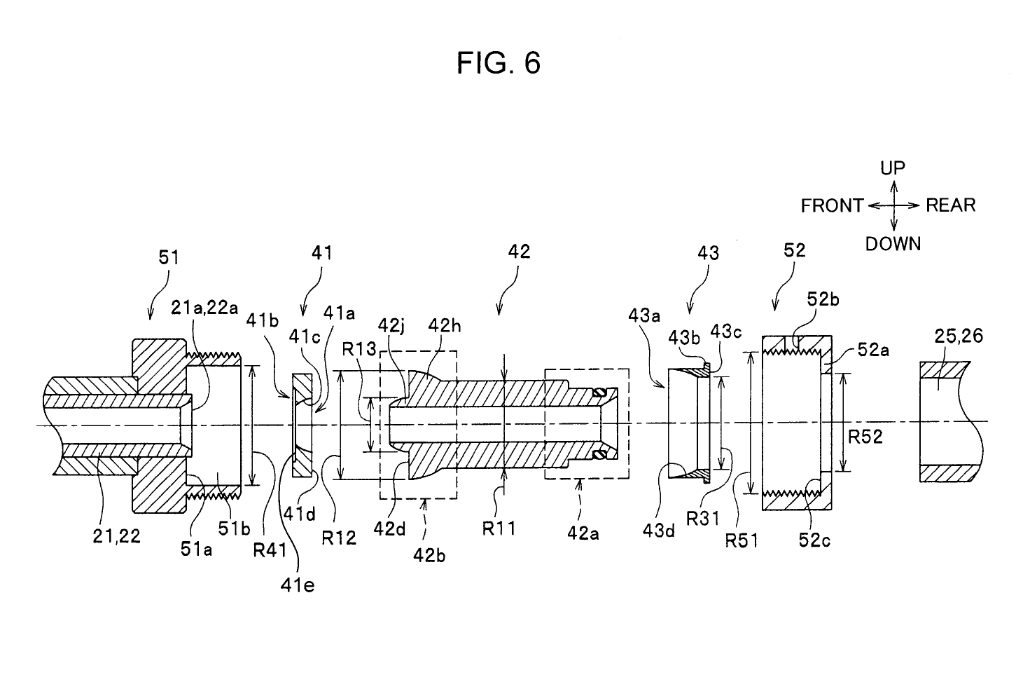

As shown in FIGS. 5 and 6, the fitting body 42 is a major member of the connection fitting 40. The fitting body 42 has a hollow tubular shape into which the welding wire W shown in FIG. 3 (see FIG. 3) is to be penetratingly inserted. The fitting body 42 has a first end (in FIGS. 5 and 6, a rear end) that is one of opposite ends thereof, the first end forming a tubular connection portion 42a to be connected to the shock sensor unit 3. The fitting body 42 has also a second end (in FIGS. 5 and 6, a front end) that is the other of the opposite ends, the second end having a spherical shaft-shaped connection portion 42b to be connected to the welding torch (21, 22). There is interposed a circular tubular portion between the first and second ends.

The tubular connection portions 42a are respective portions to be connected to the first base-end torch holding member 25 and the second base-end torch holding member 26 of the shock sensor unit 3. The configuration of each of the tubular connection portion 42a is not limited, as long as it can be connected and fixed to the corresponding base-end torch holding member. The tubular connection portion 42a in this embodiment has a circular tubular shape with an outer diameter less than an outer diameter R11 of the circular tubular portion around a longitudinal center of the fitting body 42, attached with a sealing member, such as an O-ring, for preventing leakage of shielding gas, in a vicinity of a rear edge of the tubular connection portion 42a.

The spherical shaft-shaped connection portions 42b are respective portions to be connected to the welding torch 21, 22, respectively. Each of the spherical shaft-shaped connection portions 42b has a first partial sphere 42h and a second partial sphere 42j. The first partial sphere 42h is integrally formed with the circular tubular portion through a first step structure, and has a spherical outer pheripheral surface surrounding the central axis of the connection fitting 40 and having a diameter which gradually increases with getting closer to the housing member. The maximum R12 of the diameter, which is one with respect to a direction perpendicular to the central axis, of the first partial sphere, i.e., the spherical outer pheripheral surface of the first partial sphere 42h, is greater than the outer diameter R11 of the circular tubular portion, i.e., a central portion of the fitting body 42. The second partial sphere 42j is integrally formed with the first partial sphere 42h through a second step structure, and has a spherical outer pheripheral surface surrounding the central axis of the connection fitting 40 and having a diameter which gradually decreases with getting closer to the housing member. The maximum R13 of the diameter, which is one with respect to a direction perpendicular to the central axis, of the second partial sphere, i.e., the spherical outer pheripheral surface of the second partial sphere 42j, is less than the outer diameter R11 of the circular tubular portion.

In the spherical shaft-shaped connection portion 42b, the first partial sphere 42h and the second partial sphere 42j are arranged so as to oppose their end surfaces having different diameters as mentioned above to each other, and there exists an end surface 42d in the second step structure therebetween. This configuration allows the torch-side bearing member 41 and the sensor-side bearing member 43 to be detachably installed onto the spherical shaft-shaped connection portion 42b. The first and second partial spheres 42h, 42j have respective centers of curvatures at the same point on the axis. Each of the first partial sphere 42h and the second partial sphere 42j surrounds the hollow space into which the welding wire W shown in FIG. 3 is to be penetratingly inserted.

### (Configuration of Torch-Side Bearing Member)

As shown in FIGS. 5 and 6, the torch-side bearing member 41 is a member to be attached to the spherical shaft-shaped connection portion 42b of the fitting body 42, from a front side of the spherical shaft-shaped connection portion 42b, i.e., from the second-end side, to allow an attachment angle and an attachment position of the fitting body 42 to be adjusted.

The torch-side bearing member 41 is formed in a ring shape having an outer diameter which is equal to the maximum diameter R12 of the first partial sphere 42h, or greater than the maximum diameter R13 of the second partial sphere 42j and less than the maximum diameter R12 to an extent of causing no deterioration in strength of the torch-side bearing member 41 itself. The torch-side bearing member 41 is also formed in a plate shape having a thickness direction coincident with the front-rear direction and having a thickness less than a height dimension of the second partial sphere 42j axially of the connection fitting 40.

The ring-shaped torch-side bearing member 41 has an inner surface formed with a second sliding surface 41c and a sliding contact portion 41b. The second sliding surface 41c is a curved surface having the same curvature as that of a second partial spherical surface, i.e., an outer peripheral surface of the second partial sphere 42j. The torch-side bearing member 41A has a dimension in the front-rear direction which dimension is less than a height dimension of the second partial sphere 42j in the front-rear direction. This allows the second partial sphere 42j to be slidingly moved while being fitted in the torch-side bearing member 41, until an end surface 41d of the torch-side bearing member 41 and the end surface 42d of the fitting body 42 abut against each other.

The sliding contact portion 41b is formed in a torch-side end portion of the torch-side bearing member 41. The sliding contact portion 41b is constituted by an end surface of the torch-side bearing member 41, which end surface has a recess 41e having a diameter greater than an outer diameter of each of ends 21a, 22a of respective welding torches 21, 22. The sliding contact portion 41b is slidingly movable in a state in which the respective ends 21a, 22a of the welding torch 21, 22 protruding inside the housing member 51 is inserted in the recess 41e and the sliding contact portion 41b contacts a bottom surface 51a of the housing member 51. The torch-side bearing member 41 has an outer diameter which is less than an inner diameter R41 of a bottomed circular tubular portion 51b of the housing member 51 to an extent of causing no deterioration in current conductivity. This limits the slidable range of the torch-side bearing member 41 to a range corresponding to the inner diameter R41 of the housing member 51.

### (Sensor-Side Bearing Member)

As shown in FIGS. 5 and 6, the sensor-side bearing member 43 is a member to be attached to the spherical shaft-shaped connection portion 42b of the fitting body 42 from a rear side of the spherical shaft-shaped connection portion 42b, i.e., from the first-end side, to allow the attachment angle of the fitting body 42 to be adjusted. The sensor-side bearing member 43 has a ring shape with an outer diameter approximately equal to the maximum diameter R12 of the first partial sphere 42h of the fitting body 42 and an inner diameter R31 greater than the outer diameter R11 of the circular tubular portion. The sensor-side bearing member 43 has a rear end which forms a flange 43b. The flange 43b has an outer diameter greater than the inner diameter R41 of the bottomed circular tubular portion 51b of the housing member 51 and less than an inner diameter R51 of the clamp member 52.

The sensor-side bearing member 43 has a front end which forms a bearing portion 43a. The bearing portion 43a has an inner surface formed with a first sliding surface 43d which is a curved surface having the same curvature as that of a first partial spherical surface, which is an outer peripheral surface of the first partial sphere 42h. The bearing portion 43a has a dimension in the front-rear direction which dimension is equal to a height dimension of the first partial sphere 42h in the front-rear direction. As mentioned above, the inner diameter R31 of the flange 43b is greater than the outer diameter R11 of the circular tubular portion. This allows the first partial sphere 42h to be slidingly moved by a distance corresponding to a difference between the outer diameter R11 and the inner diameter R31, while being fitted in the bearing portion 43a.

### <Configurations of Housing Member and Clamp Member>

The housing member 51 and the clamp member 52 are members for attaching the fitting body 42, which has an attachment angle and an attachment position which have been already adjusted with use of the torch-side bearing member 41 and the sensor-side bearing member 43, to respective ends 21a, 22a of the welding torches 21, 22. The housing member 51 and the clamp member 52 according to the embodiment have respective threaded structures for attaching the fitting bodies 42 to the welding torches 21, 22, respectively. In the following description, the housing member 51 and the clamp member 52 will be referred to collectively and occasionally as “fastening parts”.

The housing member 51 has the bottomed circular tubular portion 51b with the bottom surface 51a. The bottomed circular tubular portion 51b has an outer peripheral surface formed with a helical groove to serve as an external thread with respect to the clamp member. The bottomed circular tubular portion 51b has the inner diameter R41 greater than either of the diameter R12 of the first partial sphere 42h and the outer diameter of the torch-side bearing member 41. Each of the ends 21a, 22a of respective welding torches 21, 22 protrudes from the bottom 51a of the housing member 51 into the bottomed circular tubular portion 51b, the ends 21a, 22a having respective opening portions which is reversely tapered.

The clamp member 52 has a circular tubular shape with an inner peripheral surface formed with a helical groove to serve as an internal thread with respect to the housing member 51. The clamp member 52 has the inner diameter R51 greater than the outer diameter of the flange 43b. The clamp member 52 has a portion on the side of the first and second base-end torch holding members 25, 26, the portion making up a clamping portion 52a with an inner diameter R52 less than that of the outer diameter of the flange 43b of the clamping portion 52a. The clamping portion 52a has a contact surface 52c. The contact surface 52c comes into contact with an end surface 43c of the flange 43b of the sensor-side bearing member 43 accompanying the fastening of the clamp member 52 to the housing member 51, thus pressing the sensor-side bearing member 43 in a clamping direction (frontwardly, in FIG. 6). The fastening of the clamp member 52 to the housing member 51 is performed preferably by use of a tool such as a spanner or a screw wrench. The clamp member 52 is formed with a radially-extending through-hole 52b for allowing a non-shown setscrew to be inserted thereinto. The setscrew is used for loosening prevention, after fastening the clamp member 52.

Based on the above configuration, the housing member 51 and the clamp member 52 are operable to hold the connection fitting 40 movably in a direction perpendicular to the central axis of the connection fitting 40 (front-tear direction in FIGS. 5 and 6), i.e., movably in the up-down and right-left directions, in the temporarily fastened state, operable to hold the fitting bodies 42 so as to allow the fitting bodies 42 to be tilted with respect to the central axis of the connection fitting 40 (front-tear direction in FIGS. 5 and 6), and operable to fix the connection fitting 40 in a tilted state or at a position to which the connection fitting 40 had been moved, in the finally fastened state.

### <<Angle Adjustment Function and Position Adjustment Function (Offset Adjustment Function) of Connection Fitting>>

### <Angle Adjustment Function of Connection Fitting>

In the case where the welding torches 21, 22 of the tandem welding torch unit 2 (two-electrode integrated welding torch unit) shown in FIG. 2 are not parallel to each other, the welding torches 21, 22 cannot be connected to respective first and second base-end torch holding members 25, 26 which are two mutually parallel attachment ports.

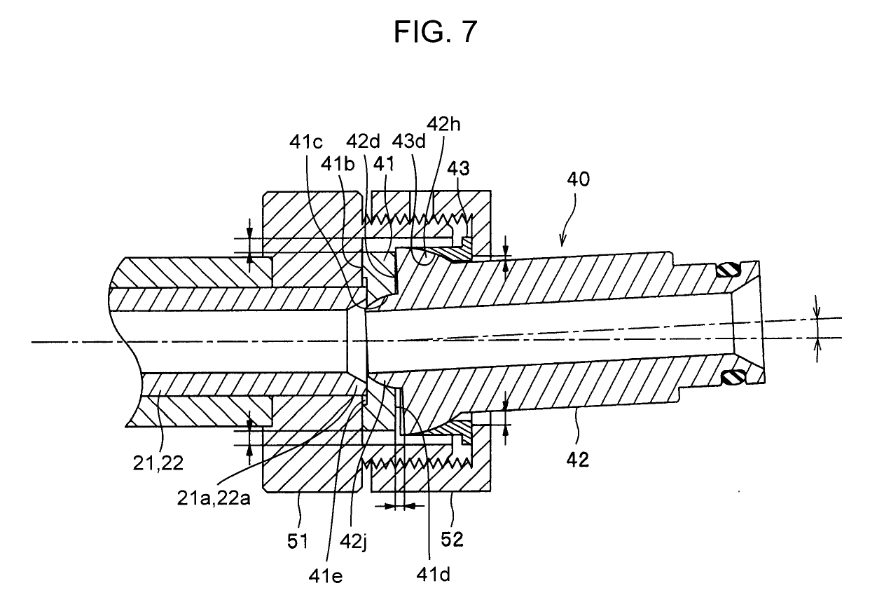

Hence, in the connection fitting 40 according to this embodiment, as shown in FIGS. 7 and 6, the clamp member 52 is fastened to the housing member 51, in a state in which the first partial spherical surface of the first partial sphere 42h is slidably mated to the first sliding surface 43d as an inner curved surface of the bearing portion 43a formed in the sensor-side bearing member 43, and a state in which the second partial spherical surface of the second partial sphere 42j is slidable mated to the second sliding surface 41c as an inner curved surface of a bearing portion 41a formed in the torch-side bearing member 41 (finally fastened state). Thus, in the connection fitting 40, the fitting body 42 having the tubular connection portion 42a formed at a movable end thereof can be tilted with respect to the central axis (angle adjustment function). There is provided a gap between the bottomed circular tubular portion 51b of the housing member 51 and the spherical shaft-shaped connection portion 42b in the connection fitting 40. This gap is a space to permit the fitting body 42 to slide so as to realize the aftermentioned position adjustment function.

As above, even when the welding torches 21, 22 of the tandem welding torch unit 2 (two-electrode integrated welding torch unit) are not parallel to each other, adjustment of the angle of each of the connection fittings 40A, 40B attached to the respective welding torches 21, 22 to make the connection fittings 40A, 40B be parallel to each other allows the welding torches 21, 22 to be connected, respectively, to the first and second base-end torch holding members 25, 26 which are two mutually parallel attachment ports of the shock sensor unit 3. Hence, the use of the connection fittings 40A, 40B makes it possible to allow the two-electrode integrated welding torch unit and the tandem-compatible shock sensor unit to be connected together within a significant short period of time, involving no needs for process and adjustment times, and a high degree of skill based on experts, necessary for ensuring bending accuracy and assembling accuracy of the welding torches 21, 22.

In addition, in the connection fitting 40, the spherical shaft-shaped connection portion 42b can keep surface contact with the second sliding surface 41c as a curved surface of the torch-side bearing member 41 irrespective of a tilt angle of the fitting body 42, which enables the angle adjustment to be performed under no negative influence on current conductivity.

In the case of necessity of limiting a tilt angle of the fitting body 42 to a given range, it is preferable to adjust at least one relationship of: a relationship between the thickness of the torch-side bearing member 41 or the height dimension of the second partial sphere 42j in the front-rear direction and the dimension of the bearing portion 41a in the front-rear direction; a relationship of the outer diameter R11 of the circular tubular portion and the inner diameter R31 of the sensor-side bearing member 43; and a relationship between the outer diameter R11 of the circular tubular portion and the inner diameter R52 of the clamp member 52, in the same manner as that for a ball joint.

### <Position Adjustment Function (Offset Adjustment Function)>

Even if the welding torches 21, 22 of the tandem welding torch unit 2 (two-electrode integrated welding torch unit) shown in FIG. 2 are parallel to each other, there can be a case where the welding torches 21, 22 are not able to be connected to the first and second base-end torch holding members 25, 26, respectively, that is, a case where the distance between respective axes of the two welding torches 21, 22 is different from the distance between respective axes of the first and second base-end torch holding members 25, 26 as two attachment ports of the shock sensor unit 3.

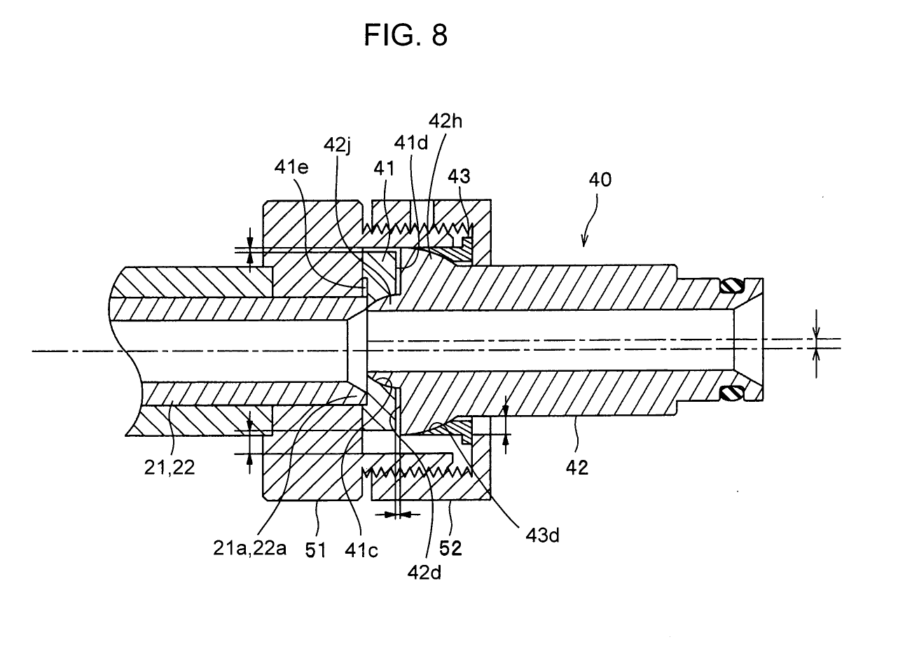

To solve the problem, as shown in FIGS. 6 and 8, in the connection fitting 40 according to this embodiment, the torch-side bearing member 41 has an outer diameter less than the inner diameter R41 of the housing member 51, thereby forming a gap between the housing member 51 and the connection fitting 40 located thereinside. This gap permits the fitting body 42, the torch-side bearing member 41 and the sensor-side bearing member 43 in an integrally assembled state to be slidingly moved inside the housing member 51 in a direction perpendicular to the central axis (up-down and right-left directions) by a distance corresponding to the gap (position adjustment function or offset adjustment function). The sliding movement enables the position adjustment to be carried out, and the clamp member 52 is fastened to the housing member 51 (finally fastened state), after the completion of the adjustment. Hence, even in the situation where there is a difference between the distance between respective axes of the two welding torches 21, 22 of the tandem welding torch unit 2 (two-electrode integrated welding torch unit), and the distance between respective axes of the first and second base-end torch holding members 25, 26 as the two attachment ports of the shock sensor unit 3, it is possible to absorb the difference in distance between the axes by adjusting the positions of the central axes so as to bring a widthwise distance between the connection fittings 40A, 40B attached to the respective welding torches 21, 22 into coincidence with a widthwise distance between the first and second base-end torch holding members of respective connection fittings 40A, 40B, thus allowing the welding torches 21, 22 to be connected to the first and second base-end torch holding members 25, 26 of the shock sensor 3, respectively. The use of the connection fittings 40A, 40B, therefore, allows the two-electrode integrated welding torch unit and the tandem-compatible shock sensor unit to be connected together within a significant short period of time, involving no needs for process and adjustment times, and a high degree of skill based on experts, necessary for ensuring bending accuracy and assembling accuracy of the welding torches 21, 22.

In the case of necessity of limiting a movable distance of the fitting body 42 to a given range, it is preferable to adjust at least one relationship of a relationship between the inner diameter of the sliding contact portion 41b and each of the outer diameter of the torch bodies 21a, 22a, and a relationship between the inner diameter of the sliding contact portion 41b or the diameter R12 of the first partial sphere 42h, and the inner diameter R41 of the housing member 51.

Although there have been explained the angle adjustment function and position adjustment function (offset adjustment function) separately with reference to FIG. 7 and FIG. 8, in a situation where the welding torches 21, 22 of the tandem welding torch unit 2 (two-electrode integrated welding torch unit) shown in FIG. 2 are not parallel to each other, the angle adjustment function and the position adjustment function (offset adjustment function) will be simultaneously performed when there is a difference between the distance between respective axes of the two welding torches 21, 22 and the distance between respective axes of the first and second base-end torch holding members 25, 26 as two attachment ports of the shock sensor unit 3. Specifically, the connection fittings 40A, 40B attached to the respective welding torches 21, 22 are allowed to be fastened by the tilt of the fitting body 42 having the tubular connection portion 42a formed at the movable end thereof with respect to the central axis and the movement thereof in a direction perpendicular to the central axis (up-down and right-left directions).

Either of the direction of the tilt of the fitting body 42 permitted by the angle adjustment function and the direction of the sliding of the fitting body 42 permitted by the position adjustment function (offset adjustment function) is a 3-dimensional direction; therefore, in the case where the two functions simultaneously exert, there can be assumed various combinations of tilt directions and sliding directions. For example, it is possible to further move the fitting body in a tilt direction, or move the fitting body in a direction opposite to the tilt direction, or move the fitting body in a direction other than the tilt direction (e.g. in a direction perpendicular to the tilt direction).

### <<Connection Method Using Connection Fitting>>

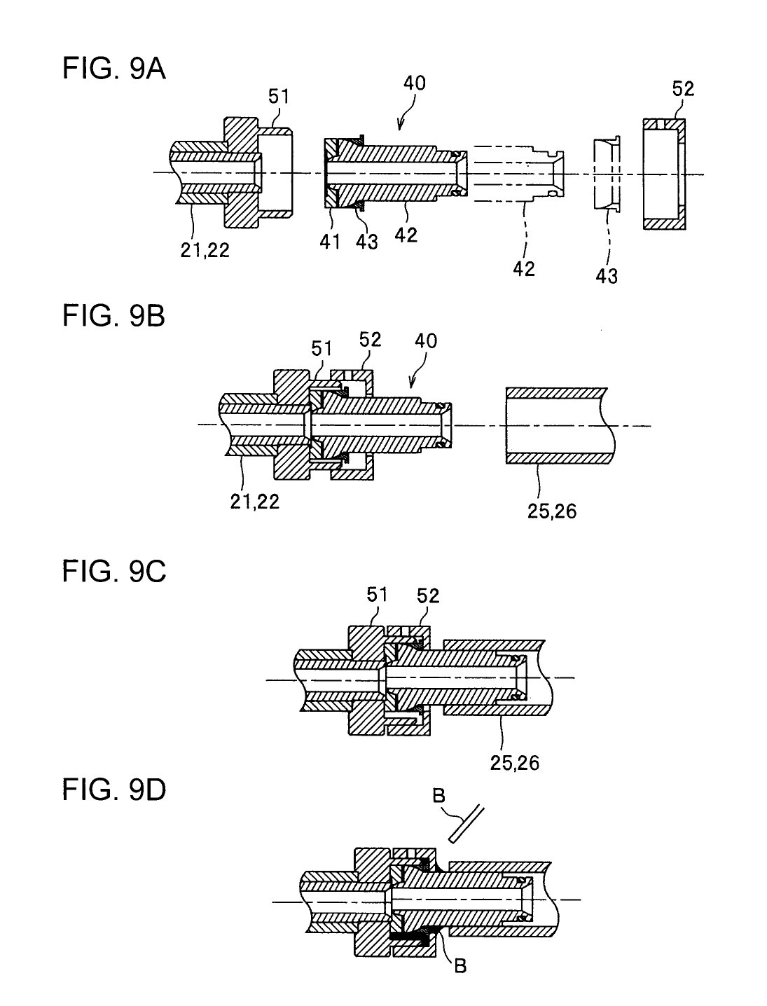

Next will be described, with reference to FIG. 9, a method of connecting the tandem welding torch unit 2 to the tandem-compatible shock sensor unit 3 by use of the connection fitting 40.

Firstly, a person who intends to connect the tandem welding torch unit 2 to the tandem-compatible shock sensor unit 3, using the connection fitting 40 (the person will hereinafter be referred to as “operator”) assembles the connection fitting 40 by attaching the torch-side bearing member 41 and the sensor-side bearing member 43 to the fitting body 42 (see FIG. 9A)

Then, the operator places each of the connection fittings 40 in the housing member 51 formed in each of the welding torches 21, 22, and performs fastening operation so as to connect the clamp members 52A, 52B to the housing members 51A, 51B, respectively, but not fully fasten them (in a temporarily fastened state; see FIG. 9B). In the temporarily fastened state, within the housing member 51, the connection fitting 40 is allowed to be slidingly moved in a direction perpendicular to the central axis (up-down and right-left directions) and be tilted with respect to the central axis, while the sliding contact portion 41b being contact with the bottom surface 51a.

Subsequently, the operator connects respective tubular connection portions 42a of the connection fittings 40 attached to the welding torches 21, 22 to the first and second base-end torch holding members 25, 26, respectively. In this process, even when there occurs a positional misalignment and/or an angular misalignment between each of the welding torches 21, 22 and each of the base-end torch holding members 25, 26, the connection fitting 40 allows the misalignment to be absorbed by sliding movement of the connection fitting 40 in a direction perpendicular to the central axis (up-down and right-left directions) and tilt of the connection fitting 40 with respect to the central axis, within a gap formed inside the housing member 51, thereby enabling the connection to be performed. The operator, thereafter, performs further fastening operation for the clamp member 52 to fully fasten the clamp member 52 to the housing member 51 (finally fastened state). The connection fitting 40 is thereby fixed, and the connection between the tandem welding torch unit 2 and the shock sensor unit 3 is thus completed (see FIG. 9C).

Furthermore, the operator may inject a brazing filler metal through the gaps between respective members to reliably fix the fitting body 42, the torch-side bearing member 41 and the sensor-side bearing member 43 of the connection fitting 40 to the clamp member. As the brazing filler metal, it is preferable to use an electrical conductive material (solder, tin, zinc, etc.). This enables the connection fitting 40 to maintain the connection between the tandem welding torch unit 2 and the shock sensor unit 3 over a long period of time while involving no negative influence on current conductivity.

As described above, in production of a welding robot, the use of the connection fitting 40 accordion to the embodiment enables the tandem welding torch unit 2 (two-electrode integrated welding torch unit) to be connected to the tandem-compatible shock sensor unit 3 under no influences of a shape of a curved type torch body and an angle defined between respective axes of two welding torches. This allows the tandem welding torch unit 2 (two-electrode integrated welding torch unit) to be produced involving no need for sophisticated bending technique and taking a lot of time for assembling.

### [Modifications]

Although the present invention has been described based on a specific embodiment thereof, it is to be understood that the present invention is not limited thereto, but various changes and modifications may be made therein without departing from the spirit and scope thereof as set forth in appended claims. Some example of such modifications will be described below.

In the connection fitting 40 according to the above embodiment, the maximum diameter R12 of the first partial sphere 42h of the spherical shaft-shaped connection portion 42b is greater than the outer diameter R11 of the circular tubular portion and the maximum diameter R13 of the second partial sphere 42j is less than the outer diameter R11 of the circular tubular portion, i.e., there is the following relationship: the maximum diameter R13 of the second partial sphere 42j<R11 of the circular tubular portion<the maximum diameter R12 of the first partial sphere 42h; however, the diameter R13 of the second partial sphere 42j may be set within the range between R11 of the circular tubular portion and the maximum diameter R12 of the first partial sphere 42h.

Although the connection fitting 40 according to the above embodiment is made of the same material as that for the welding torches 21, 22 in view of current conductivity, a different material having similar electrical conductivity may be used. The sensor-side bearing member 43, exerting no negative influence on welding current as compared to other members, may be made of a material different from that for the torch-side bearing member 41 and the fitting body 42 in terms of current conductivity, e.g., an insulating material such as rubber.

Although the connection fitting 40 according to the above embodiment includes the spherical shaft-shaped connection portion 42b on the tandem welding torch unit 2 side and the tubular connection portion 42a on the shock sensor unit 3 side, the tubular connection portion 42a may be on the tandem welding torch unit 2 side and the spherical shaft-shaped connection portion 42b may be on the shock sensor unit 3 side. In this case, the configurations of the torch-side bearing member 41 and the sensor-side bearing member 43 may be reversed.

As mentioned above, the present invention provides: a connection fitting capable of interconnecting a two-electrode integrated welding torch unit and a tandem-compatible shock sensor unit within a short period of time, involving no needs for process and adjustment times, and a high degree of skill based on experts, necessary for ensuring torch bending accuracy and assembling accuracy; and a connection method using the connection fitting.

According to one aspect of the present invention, provided is a connection fitting for interconnecting a two-electrode integrated welding torch unit having two connection portions and a shock sensor unit having two attachment ports, wherein the connection fitting is adapted to be fixed to each connection portion of the two-electrode integrated welding torch unit by use of tubular fastening parts to connect each of the connection portions of the two-electrode integrated welding torch unit to corresponding one of the attachment ports of the shock sensor unit. The connection fitting comprises: a tubular fitting body including a first end formed with a tubular connection portion to be connected to the shock sensor unit and a second end which is opposite to the first end, the second end having a spherical shaft-shaped connection portion which is integrally formed with a first partial spherical surface and a second partial spherical surface each having a difference curvature to be connected to the connection portion of the two-electrode integrated welding torch unit; a first bearing member ring-shaped to have an inner surface formed with a first sliding surface slidable with respect to the first partial spherical surface of the spherical shaft-shaped connection portion, the first bearing member being configured to be attached to the fitting body from a first-end side of the tubular fitting body in a state in which the first partial spherical surface and the first sliding surface are opposed to each other; a second bearing member ring-shaped to have an inner surface formed with a second sliding surface slidable with respect to the second partial spherical surface of the spherical shaft-shaped connection portion, the second bearing member being configured to be attached to the fitting body from a second-end side of the tubular fitting body in a state in which the second partial spherical surface and the second sliding surface are opposed to each other and the second bearing member contacts an end surface of the connection portion of the two-electrode integrated welding torch unit, wherein the second bearing member includes a sliding contact portion having an outer diameter less than an inner diameter of the fastening parts, the sliding contact portion configured to slidably contact the end surface of the connection portion of the two-electrode integrated welding torch unit.

In this connection fitting, the first partial spherical surface and the second partial spherical surface of the spherical shaft-shaped connection portion can be slidingly moved on the first sliding surface and the second sliding surface, respectively, thus enabling the angle of the fitting body to be connected to the shock sensor to be freely adjusted (angle adjustment function). Hence, even when two welding torches of the two-electrode integrated welding torch unit are not parallel to each other, the welding torches can be connected, respectively, to two mutually parallel attachment ports of the shock sensor, by simple adjustment of the angles of the connection fittings so as to make the connection fittings attached to the respective connection portions of the welding torches be parallel to each other.

In the above connection fitting, the sliding movement of the second bearing member within the fastening parts enables the position of the central axis of the fitting body to be connected to the shock sensor to be freely adjusted (position adjustment function (offset adjustment function)). Thus, even when there exists a difference between the distance between respective axes of the two welding torches of the two-electrode integrated welding torch unit and the distance between respective axes of the two attachment ports of the shock sensor unit, adjusting the positions of the central axes of the connection fittings so as to bring a widthwise distance between the connection fittings attached to the respective connection portions of the welding torches into coincidence with the widthwise distance between the two attachment ports allows the difference in the distance between the axes to be absorbed, thus allowing the welding torches to be connected to the two attachment ports of the shock sensor respectively.

Furthermore, the above connection fitting, whose spherical shaft-shaped connection portion keeps surface contact with the second sliding surface irrespective of a tilt angle of the fitting body, makes it possible to perform the angle adjustment without exerting a negative influence on current conductivity and airtightness.

Preferably, the fitting body further includes a circular tubular portion, wherein the first partial spherical surface has a diameter in a direction perpendicular to an axial direction of the fitting body, a maximum of the diameter of the first partial spherical surface being greater than an outer diameter of the circular tubular portion, and the second partial spherical surface has a diameter in the direction perpendicular to the axial direction of the fitting body, a maximum of the diameter of the second partial spherical surface being less than the outer diameter of the circular tubular portion. This allows the second partial sphere to have a small dimension as compared to the first partial sphere, thereby making it possible to downsize the connection fitting itself and cope with welding torches having various sizes.

Preferably, the second bearing member includes a plate-shaped portion having the second sliding surface, wherein the plate-shaped portion has a thickness less than a height dimension of the second partial spherical surface. This makes it possible to form a given interspace between the second bearing member and the first partial sphere, thus allowing the tilt angle of the fitting body to be adjusted in a certain range corresponding to the interspace.

Preferably, the fitting body, the first bearing member and the second bearing member are brazed and fixed to the fastening parts by use of an electrical conductive brazing filler metal. This allows the fitting body, the first bearing member and the second bearing member to be fixed to the fastening parts with stronger force, thus allowing the interconnection of the two-electrode integrated welding torch unit and the shock sensor to be maintained over a long period of time while involving no negative influence on current conductivity.

According to another aspect of the present invention, provided is a method of connecting a two-electrode integrated welding torch unit to a shock sensor unit installed at a distal end of a robot arm, using the above connection fitting. The method comprises: a first step of placing the spherical shaft-shaped connection portion, to which the first bearing member and the second bearing member has been attached, inside the tubular fastening parts, in a temporarily fastened state, to expose the tubular connection portion of the connection fitting to an outside of the fastening parts; a second step of connecting the tubular connection portion to the shock sensor unit and fastening the fastening parts; and a third step of brazing the fitting body, the first bearing member and the second bearing member to the fastening parts with use of an electrical conductive brazing filler metal.

This connection method enables the angle of the fitting body to be connected to the shock sensor to be freely adjusted (angle adjustment function), and enables the central axis of the fitting body to be freely adjusted (position adjustment function or offset adjustment function). Thus, the two-electrode integrated welding torch unit and the shock sensor can be interconnected under no influences of a shape of a curved type torch body and an angle defined between respective axes of two welding torches.

This application is based on Japanese Patent application No. 2013-029171 filed in Japan Patent Office on Feb. 18, 2013, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A connection fitting for interconnecting a two-electrode integrated welding torch unit having two connection portions and a shock sensor unit having two attachment ports, wherein the connection fitting is adapted to be fixed to each connection portion of the two-electrode integrated welding torch unit by use of tubular fastening parts to connect each of the connection portions of the two-electrode integrated welding torch unit to corresponding one of the attachment ports of the shock sensor unit, the connection fitting comprising:
a tubular fitting body including a first end formed with a tubular connection portion to be connected to the shock sensor unit and a second end which is opposite to the first end, the second end having a spherical shaft-shaped connection portion which is integrally formed with a first partial spherical surface and a second partial spherical surface each having a difference curvature to be connected to the connection portion of the two-electrode integrated welding torch unit;
a first bearing member ring-shaped to have an inner surface formed with a first sliding surface slidable with respect to the first partial spherical surface of the spherical shaft-shaped connection portion, the first bearing member being configured to be attached to the fitting body from a first-end side of the tubular fitting body in a state in which the first partial spherical surface and the first sliding surface are opposed to each other;
a second bearing member ring-shaped to have an inner surface formed with a second sliding surface slidable with respect to the second partial spherical surface of the spherical shaft-shaped connection portion, the second bearing member being configured to be attached to the fitting body from a second-end side of the tubular fitting body in a state in which the second partial spherical surface and the second sliding surface are opposed to each other and the second bearing member contacts an end surface of the connection portion of the two-electrode integrated welding torch unit,
wherein the second bearing member includes a sliding contact portion having an outer diameter less than an inner diameter of the fastening parts, the sliding contact portion configured to slidably contact the end surface of the connection portion of the two-electrode integrated welding torch unit.

2. The connection fitting as defined in claim 1, wherein: the fitting body further includes a circular tubular portion; the first partial spherical surface has a diameter in a direction perpendicular to an axial direction of the fitting body, a maximum of the diameter of the first partial spherical surface being greater than an outer diameter of the circular tubular portion; and the second partial spherical surface has a diameter in the direction perpendicular to the axial direction of the fitting body, a maximum of the diameter of the second partial spherical surface being less than the outer diameter of the circular tubular portion.

3. The connection fitting as defined in claim 2, wherein the second bearing member includes a plate-shaped portion having the second sliding surface, the plate-shaped portion having a thickness less than a height dimension of the second partial spherical surface.

4. The connection fitting as defined in claim 1, wherein the fitting body, the first bearing member and the second bearing member are brazed and fixed to the fastening parts by use of an electrical conductive brazing filler metal.

5. A method of connecting a two-electrode integrated welding torch unit to a shock sensor unit installed at a distal end of a robot arm, using the connection fitting as defined in claim 1, comprising:
a first step of placing the spherical shaft-shaped connection portion, to which the first bearing member and the second bearing member are attached, inside the tubular fastening parts, in a temporarily fastened state, to expose the tubular connection portion of the connection fitting to an outside of the fastening parts;
a second step of connecting the tubular connection portion to the shock sensor unit and fastening the fastening parts; and
a third step of brazing the fitting body, the first bearing member and the second bearing member to the fastening parts by use of an electrical conductive brazing filler metal.
